(19) United States
(12) Patent Application Publication
(10) Pub. No.: US 2012/0174292 A1
(43) Pub. Date: Jul. 12, 2012

(54) CLOTHING RETAINER

(75) Inventor: Doug Sneyd, Orillia (CA)

(73) Assignee: Sneyd Syndicate Inc., Orillia (CA)

(21) Appl. No.: 13/347,499

(22) Filed: Jan. 10, 2012

Related U.S. Application Data
(60) Provisional application No. 61/431,263, filed on Jan. 10, 2011.

(51) Int. Cl. A41F 1/00; B23P 19/04; A44B 99/00; A41F 9/00

(52) U.S. Cl. 2/338; 2/336; 29/428; 24/3.12

(57) ABSTRACT

A clothing retainer has a body with a pair of abutments spaced apart along the body. Each of the abutments includes a hook having a mouth for engagement with a fastener on clothing. The mouths are oppositely directed toward one another and inhibit separation of the fasteners engaged by the hooks.

### CROSS REFERENCE

This application claims priority from a U.S. Provisional Patent Application No. 61/431,263 filed Jan. 10, 2011.

### FIELD OF THE INVENTION

The present invention relates to a retainer to maintain items of clothing in a preferred disposition.

Articles of clothing are designed to provide an aesthetically pleasing appearance and in order to do that they must be maintained in the intended disposition on the wearer.

This is particularly relevant to the retention of a shirt within the waistband of a pair of pants, where even normal usage can result in the shirt becoming loose. This problem is aggravated if the user engages in energetic activities such as dancing or athletic events.

### DESCRIPTION OF THE PRIOR ART

Typically, pants have been supported by suspenders extending from the pants and over the shoulders. These, however, are relatively expensive and conspicuous. An adaptation of these is the elastic support system shown in U.S. Pat. No. 5,488,738. Such a system, however, envisages a relatively cumbersome elastic suspender that does not lend itself to normal usage.

U.S. Pat. No. 5,802,612 and U.S. Patent Applications No. 2006/0010559 and 2006/0048266 each envisage the application of adhesive patches to secure a shirt within a waistband, but this requires specific treatment of the shirt material.

U.S. Pat. No. 6,175,993 shows a safety pin type of arrangement intended to lock a shirt town undergarment. This device requires the shirt to be pierced by the barb of the pin which therefore causes damage to the article of clothing.

It is therefore an object of the present invention to obviate or mitigate the above disadvantages.

### SUMMARY OF THE INVENTION

According to one aspect of the present invention there is provided a clothing retainer comprising a body having a pair of abutments spaced apart along the body. Each of the abutments includes a hook having a mouth for engagement with a fastener on the clothing. The mouths arc oppositely directed toward one another to inhibit separation of the fasteners engaged by the hooks.

Preferably the retainer includes a bracket protruding from the body for engagement with a belt.

In use, the hooks may engage respective fasteners, such as buttons, of the shirts and pants, and thereby inhibit separation of the shirt from the pants. The bracket may be used to support the belt and maintain that in a predetermined disposition.

### BRIEF DESCRIPTION OF THE DRAWINGS

An embodiment to the invention will now be described by way of example only with reference to the accompanying drawings in which:

FIG. 1 is a general perspective view of a clothing retainer.

FIG. 2 is a view from the under side of the retainer of FIG. 1 with components in ghosted outline to show the construction.

FIG. 3 is a series of views showing installation of the retainer with:

FIG. 3a shows a schematic representation of the initial step in the installation of the retainer of FIGS. 1 and 2.

FIG. 3b shows a further step,

FIG. 3c shows the installation of a belt, and FIG. 3d shows the final installation.

### DETAILED DESCRIPTION OF THE INVENTION

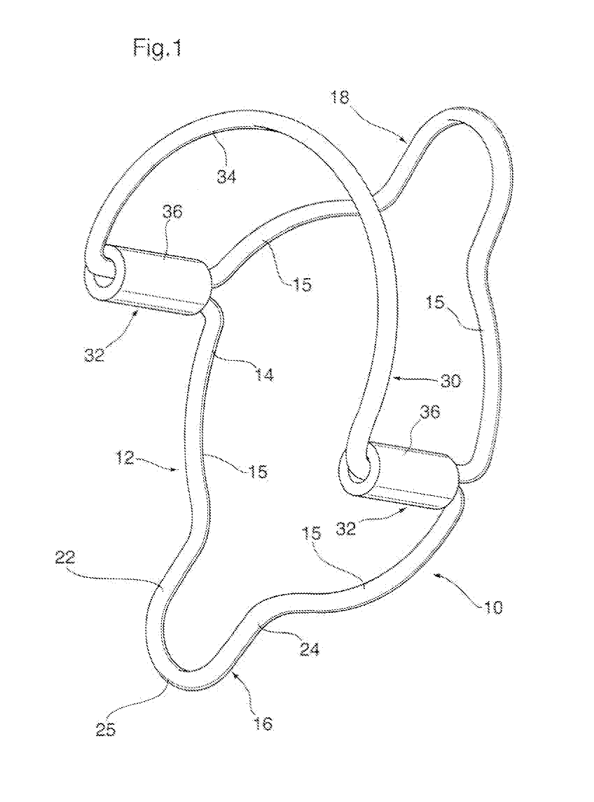

Referring therefore to FIG. 1, a clothing retainer, generally indicated at 10, includes a body 12 formed by a wire frame. A central portion 14 of the body 12 has a pair of curved side members 15 to define a generally oval and is subtended by a pair of hooks 16, 18 at diametrically opposed locations on the central portion 14.

Each of the hooks 16, 18 has a mouth 20 and a pair of limbs 22, 24 extending in spaced relationship from the mouth 20. A bight 26 connects limbs 22. 24 to provide an enclosed hook 16, 18.

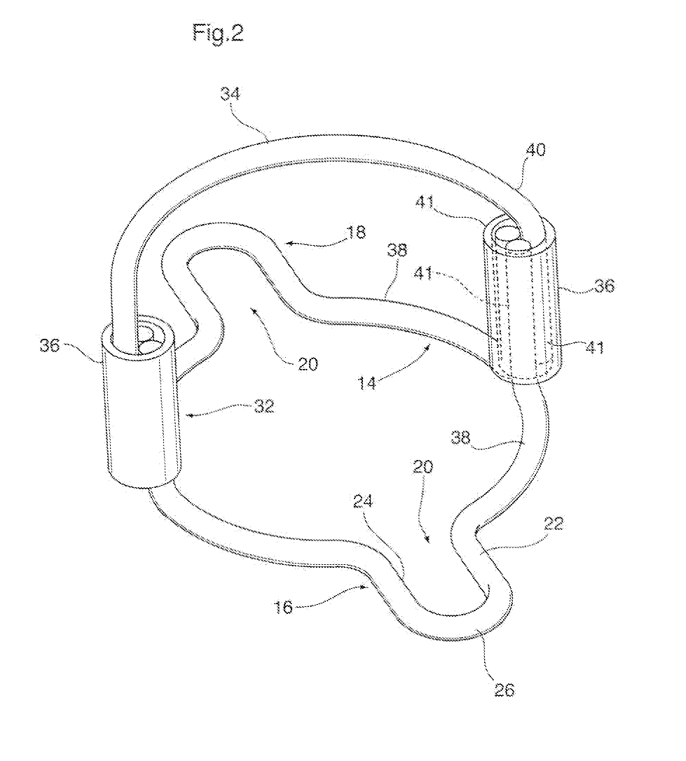

A bracket indicated at 30 projects from the central portion 14 and includes a pair of arms 32. A rail 34 extends between the arms 32 and may be of an arcuate shape, as shown in FIGS. 1 and 2, or a rectilinear shape.

The arms 32 are encompassed by sleeves 36 that function to retain the components of the body 12 in a unitary manner.

As can best be seen in FIG. 2, the body 12 of retainer 10 is formed from three pieces of wire interconnected, at the sleeve 36. Although a single length of wire could be used. for production purposes the use of three separate pieces is preferred. The body 12 is formed from top and bottom preforms 38, that are identical, and a bracket preform 40. The preforms 38, 40 are each bent outwardly, at their distal ends, as indicated at 41, so that they may be nested within the sleeve 36. The sleeve 36 may then be crimped in situ to hold the preforms securely to one another.

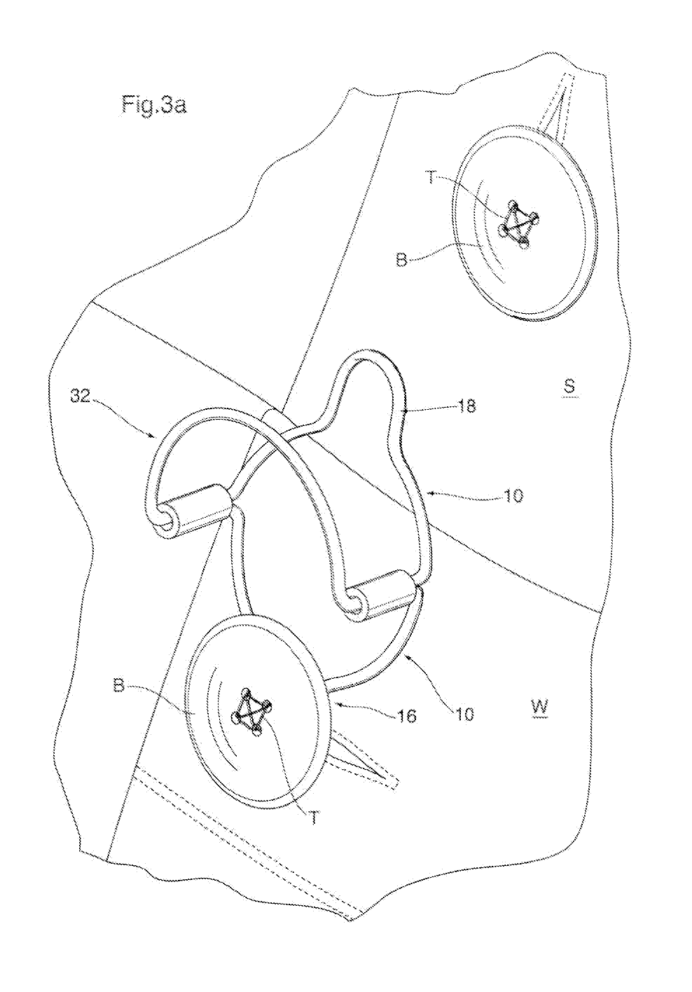

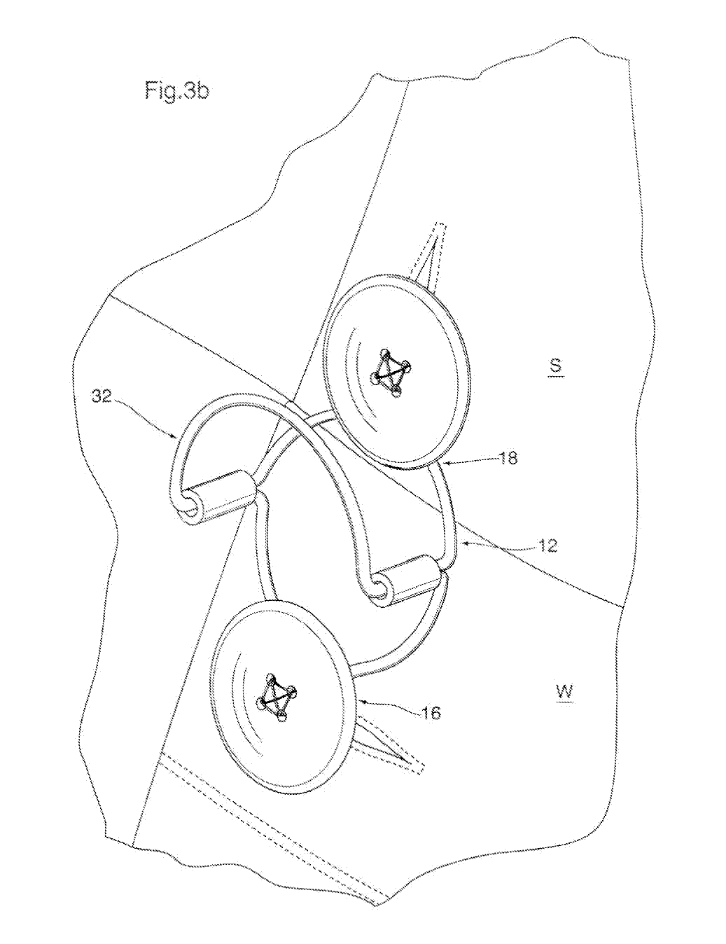

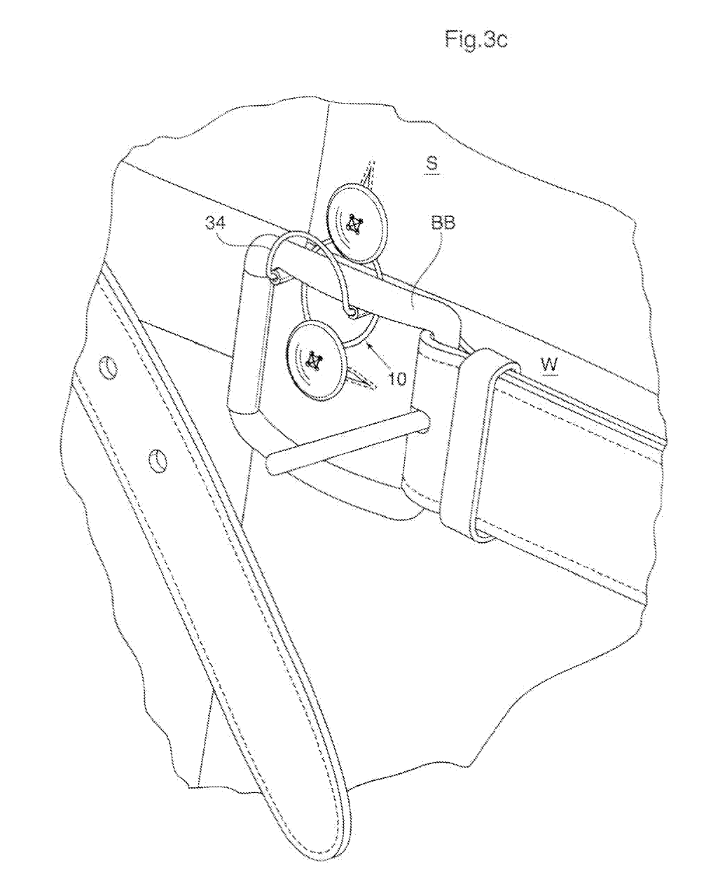

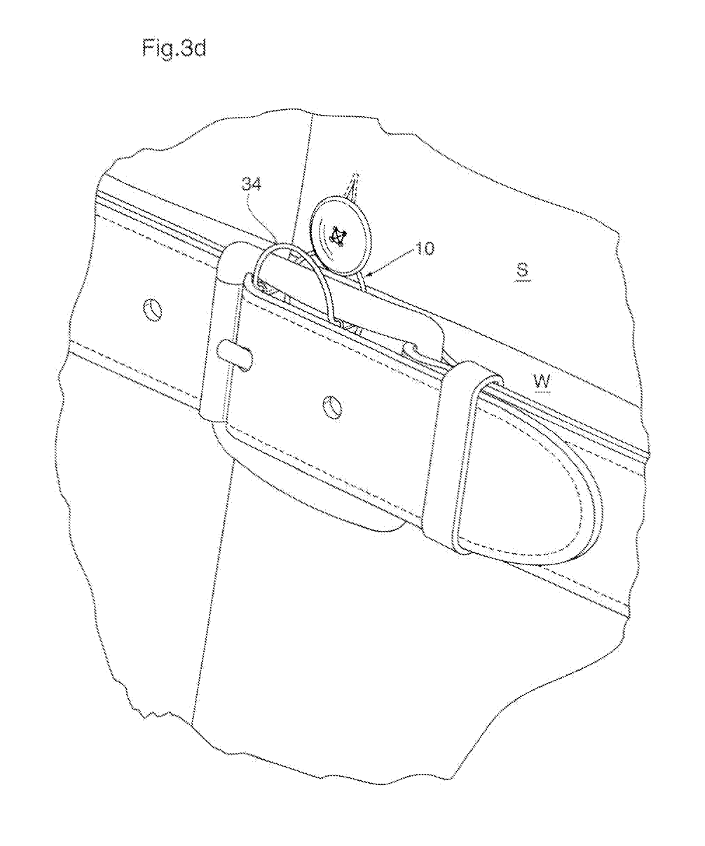

As shown in FIG. 3, the retainer 10 is used to interconnect a shirt indicated at “S” and a waistband of pants indicated at “W”. The shirt “S” includes buttons “B” that are sewn to the shirt using a length of thread “T” in the normal matter. Similarly, a button “B” is provided on the waistband “W” secured by thread “T”.

The central portion 14 is dimensioned to allow the buttons “B” to pass through and for the hook 16 to pass behind the button “B” on the waistband and engage the thread “T”.

Thereafter, as shown in FIG. 3b, a similar procedure is completed with the button “13” associated with the shirt “S”, so that the thread that secures the shirt button “B” is engaged by the hook 18. When installed in this manner, separation of the shirt “S” from the waistband is inhibited.

The bracket 30 is used to locate the belt buckle, indicated at “BB” on FIG. 3c by locating the rail 34 through the aperture of the belt buckle so that it properly supports the belt relative to the waist band “W” of the pant “P”. The opposite end of the belt may then be threaded through the buckle. The bracket 30 does not interfere with its normal use.

As shown in FIG. 3d, with the belt fastened, the retainer is unobtrusive and largely hidden by the buckle “BB” of the belt.

In use the rigidity of the wire used to form the body 12 inhibits separation of the shirt from the pant by engagement with the respective buttons. The retainer 10 may readily be removed after use by simply unhooking the retainer from the belt buckle and the two buttons. The retainer 10 is maintained in contact with the buttons by the tension applied by gravity acting on the pants P, which is resisted by the shirt S. The hooks 16, 18 are dimensioned to fit snugly around the thread T and so secure the retainer against inadvertent disengagement. As the bracket 30 locates the belt vertically, it has been found unnecessary to tighten the belt unduly. This facilitates engagement of the belt buckle with the bracket.

The wire used to form the retainer has sufficient ductility to allow it to be bent into shape but also sufficient rigidity to maintain its shape in normal use. Typically a 304 annealed stainless steel wire having a nominal diameter of 0.0475 inches (18 gauge) has the required characteristics.

It will be appreciated that the bracket 30 may be omitted if preferred where it is envisaged that a belt will not be utilized.

What is claimed is:

1. A clothing retainer comprising a body having a pair of abutments spaced apart along the body, each of the abutments including a hook having a mouth for engagement with a fastener on clothing, the mouths being oppositely directed toward one another to inhibit separation of the fasteners engaged by the hooks.

2. The clothing retainer of claim 1, wherein the body further comprises a bracket projecting away from the pair of abutments, the bracket for engagement with a belt buckle.

3. The clothing retainer of claim 2 wherein said bracket includes a rail spaced from said abutments.

4. The clothing retainer of claim 3 wherein said rail is connected to said abutments by a pair of arms extending between opposite ends of said rail.

5. The clothing retainer of claim 3 wherein said rail is accurate.

6. The clothing retainer of claim 1 wherein each of said abutments includes a pair of side frames diverging from said mouth to provide a central portion through which said fastener may pass.

7. The clothing retainer of claim 1 wherein said body is a wire frame.

8. The clothing retainer of claim 7, wherein the body is formed from a plurality of wires, each wire having a pair of distal ends, each distal end of a wire being interconnected to at least a distal end of another wire.

9. The clothing retainer of claim 8, wherein each abutment and the bracket are separate wires.

10. The clothing retainer of claim 8, wherein distal ends are interconnected by nesting into a sleeve.

11. The clothing retainer of claim 7, wherein each hook is for engagement with a thread of a button of the fastener.

12. The clothing retainer of claim 7, wherein the body is made of a single wire.

13. A method of constructing a clothing retainer comprising:
shaping at least one wire to form a body having a pair of abutments spaced apart alone the body, each of the abutments including a hook having a mouth for engagement with a fastener on clothing, the mouths being oppositely directed toward one another to inhibit separation of the fasteners engaged by the hooks.

14. The method of claim 13, wherein the body further comprises a bracket projecting away from the pair of abutments, the bracket for engagement with a belt buckle.

15. The method of claim 14, wherein a plurality of wires are used, each wire having a pair of distal ends, each distal end of a wire being interconnected to at least a distal end of another wire.

16. The method of claim 14, wherein each abutment and the bracket are separate wires.

17. The method of claim 14, wherein distal ends are interconnected by nesting into a sleeve.

18. A method of inhibiting separation of a first clothing from a second clothing comprising coupling a first fastener of the first clothing to a second fastener of the second clothing.

19. The method of claim 18, wherein the first fastener is coupled to the second fastener by a clothing retainer comprising a body having a pair of abutments spaced apart along the body, each of the abutments including a hook having a mouth for engagement with a fastener on clothing, the mouths being oppositely directed toward one another to inhibit separation of the fasteners engaged by the hooks.

20. The method of claim 19, wherein the body further comprises a bracket projecting away from the pair of abutments, the bracket for engagement with a belt buckle.
